(19) United States
(12) Patent Application Publication
(10) Pub. No.: US 2010/0180650 A1
(43) Pub. Date: Jul. 22, 2010

(54) Anti-theft lock

(76) Inventor: Tien-Kao Liu, Pingtung County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,079

(22) Filed: Jan. 16, 2009

(51) Int. Cl. E05B 27/00

(52) U.S. Cl. 70/358

(57) ABSTRACT

An anti-theft lock includes a cylinder having multiple upper pin holes and a core is rotatably received in the cylindrical recess and has multiple lower pin holes which communicate with the upper pin holes. Each lower pin hole includes a shoulder located close to the wall of the core. A lower pin, an upper pin, a spring and a cap are installed into the aligned lower pin hole and upper pin hole in sequence. A special lower pin, a special upper pin, one of the springs and one of the caps are received in one of the aligned upper pin hole and lower pin hole. The special upper pin includes ridges rested on the shoulder of the lower pin hole and a gap is defined between the special upper pin and the special lower pin.

### FIELD OF THE INVENTION

The present invention relates to an anti-theft lock which includes a special upper pin and special lower pin to prevent unauthorized key to unlock the lock.

### BACKGROUND OF THE INVENTION

A conventional lock is shown in FIG. 1 and generally includes a cylinder 10 and a core 20 which is received in the cylinder 10. The cylinder 10 includes multiple upper pin holes 101 and the core 20 includes multiple lower pin holes 201 which are located in alignment with the upper pin holes 101. A pin unit includes multiple upper pins 40, lower pins 30, springs 50 and caps 60. The lower pins 30, the upper pins 40, the springs 50 and the caps 60 are installed into the lower pin holes 201 and the upper pin holes 101 in sequence so that the bottoms of the lower pins 30 are in contact with an inner bottom of the lower pin holes 201 and the tops of the lower pins 30 are in contact with the bottoms of the upper pins 40. The springs 50 are in contact between the tops of the upper pins 40 and the caps 60 which seal the opening of the top pin holes 101. When a correct key 70 is used and inserted into the key hole in the core 20, the serrations of the key 70 push the lower pins 30 upward and the upper pins 40 are pushed by the lower pins 30, such that the tops of the lower pins 30 and the bottoms of the upper pins 40 are located at the rotational surface between the core 20 and the cylinder 10. The core 20 is then able to be rotated to unlock the lock.

Nevertheless, if a universal key 70′ or an L-shaped plate (not shown) is used and try to unlock the lock as shown in FIG. 3, the serrations of the universal key 70′ cannot push the lower pins 30 and the upper pins 40 to the correct positions. The user using the universal key 70′ will rotate the universal key 70′ to off align the lower pin holes 201 from the upper pin holes 101 as shown in FIG. 4, the upper pins 40 are then clamped between the sidewalls of the lower pin holes 201 and the upper pin holes 101. The user then pushes or applies a sudden force to the universal key 70′ as shown in FIG. 5, the inclined surfaces of the serrations of the universal key 70′ push the lower pins 30 upward to move the upper pin 40 upward and to compress the springs 50. When the springs 50 return to push the upper pins 40, because the off-alignment of the upper pin holes 101 and the lower pin holes 201, the upper pins 40 cannot drop into the lower pin holes 201 but the lower pins 30 drop into the lower pin holes 201 as shown in FIGS. 6 and 7. By repeatedly the actions, the upper pins 40 and the lower pins 30 will be arranged to the correct positions so that the lock can be unlocked. It is clear that the conventional locks do not have proper anti-theft function.

The present invention intends to provide a lock which includes a special upper pin and a special lower pin, wherein the upper pin cannot be pushed by the special lower pin by unauthorized key so that the core cannot be rotated.

### SUMMARY OF THE INVENTION

The present invention relates to an anti-theft lock which comprises a cylinder having a cylindrical recess defined therein and a core is rotatably received in the cylindrical recess. A frame is connected radially to the cylinder and multiple upper pin holes are defined through the frame and communicate with the cylindrical recess. The core includes multiple lower pin holes defined radially through a wall of the core. A keyhole is defined in a first end of the core and communicates with the lower pin holes. The lower pin holes are in alignment with the upper pin holes. Each lower pin hole includes a shoulder located close to the wall of the core.

A pin unit includes multiple lower pins, upper pins, springs and caps, wherein the lower pins, the upper pins, the springs and the caps are installed into the lower pin holes and the upper pin holes in sequence. The lower pins are located in the lower pin holes. The bottoms of the lower pins are in contact with respective inner bottoms of the lower pin holes and the tops of the lower pins are in contact with bottoms of the upper pins. The springs are in contact between tops of the upper pins and the caps which seal opening of the top pin holes. A special lower pin, a special upper pin, one of the springs and one of the caps are received in one of the aligned upper pin hole and lower pin hole. The special upper pin includes ridges protruding outward therefrom and the ridges of the special upper pin are rested on the shoulder of the lower pin hole. A gap is defined between the special upper pin and the special lower pin.

The primary object of the present invention is to provide a lock which cannot be unlocked by the conventional universal key.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a side view of a conventional lock;

FIG. 2 shows that a correct key is inserted into the core of the conventional lock;

FIG. 3 shows that a universal key is inserted into the core of the conventional lock;

FIG. 4 is a cross sectional view taken along line A-A in FIG. 3;

FIG. 5 shows the universal key is pushed to move the lower and upper pins of the conventional lock;

FIG. 6 shows the lower and upper pins are pushed to the unlock positions by using the universal key;

FIG. 7 is a cross sectional view taken along line B-B in FIG. 6;

FIG. 8 is an exploded view to show the lock of the present invention;

FIG. 9 shows a side view of the lock of the present invention;

FIG. 9-1 shows an enlarged view to show that the ridges of the special upper pin are rested on the shoulders of the lower pin hole;

FIG. 10 shows a correct key is inserted into the core to push the lower and upper pins to correct positions;

FIG. 10-1 is an enlarged view to show that the special upper pin is pushed by the special lower pin to the correct position;

FIG. 11 shows a universal key is inserted into the core of the lock of the present invention;

FIG. 12 is a cross sectional view taken along line C-C in FIG. 11;

FIG. 13 is a cross sectional view taken along line D-D in FIG. 11;

FIG. 14 shows that the upper and lower pins freely drop when the universal key rotates the core a small angle, and

FIG. 15 shows that the special upper and lower pins can be installed to any one of the aligned upper and lower pin holes.

### DETAILED DESCRIPTION OF THE PREFERRED EMBODIMENT

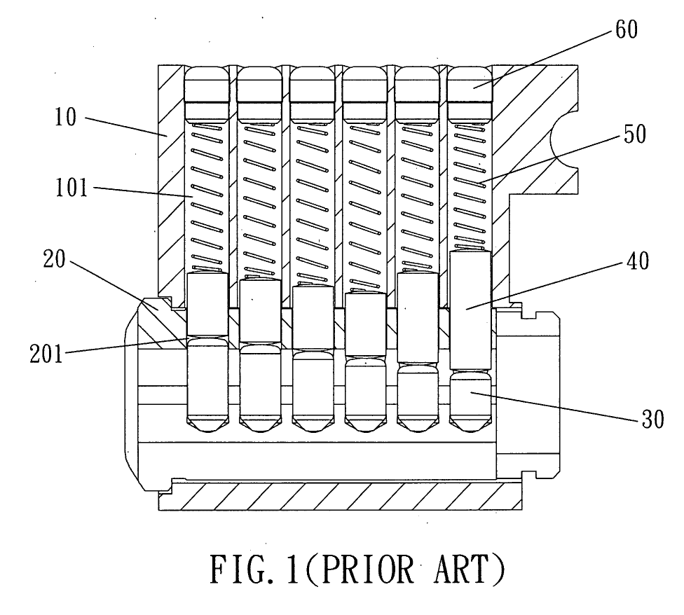

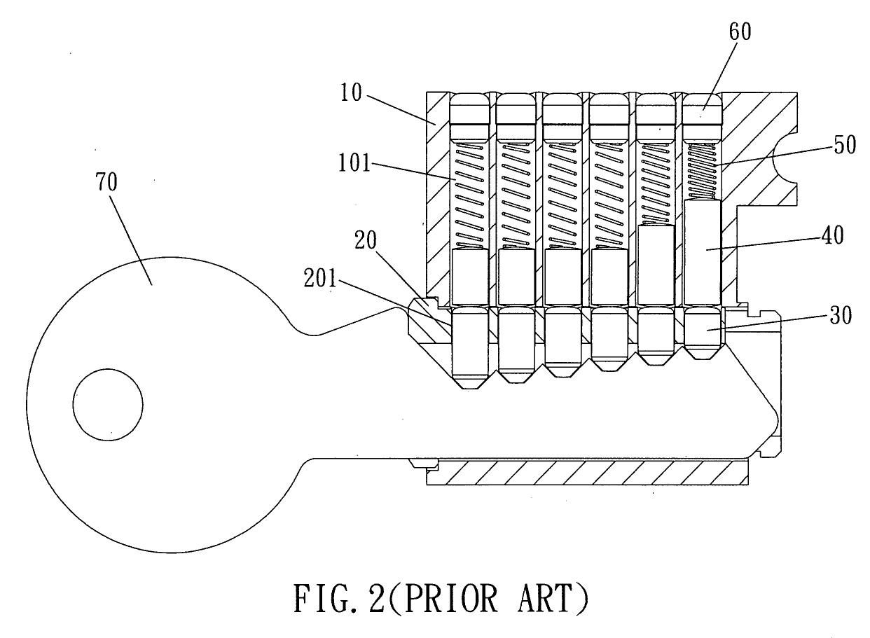

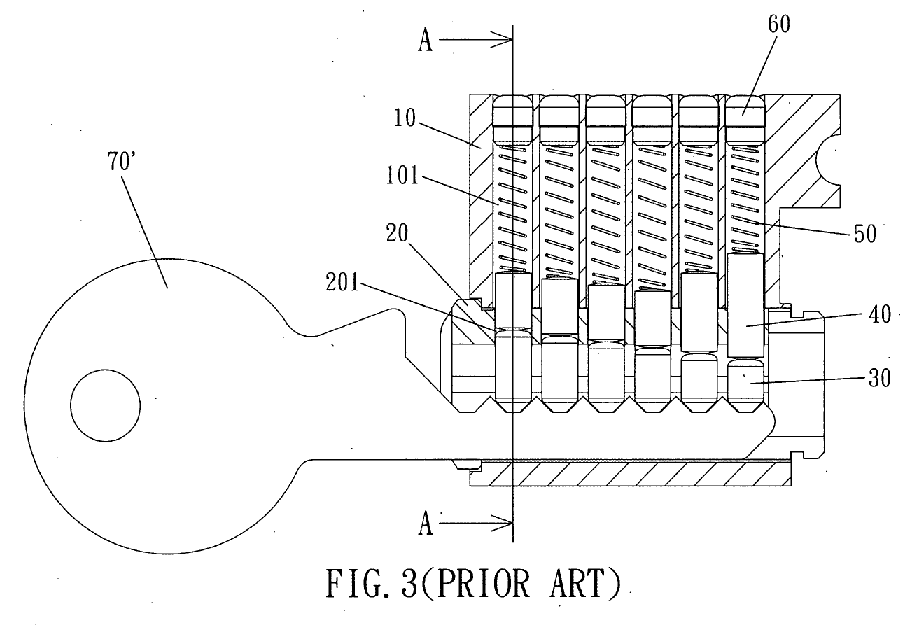

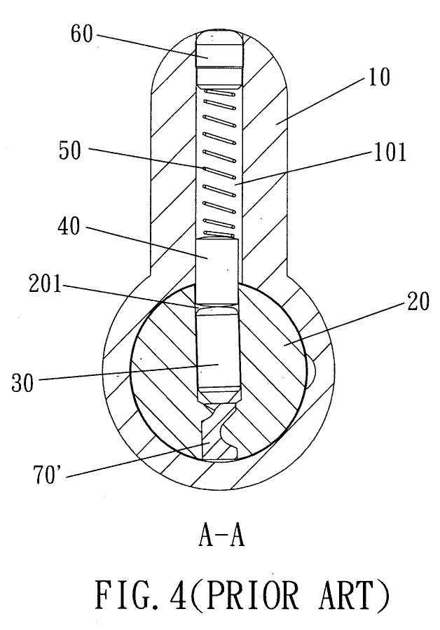

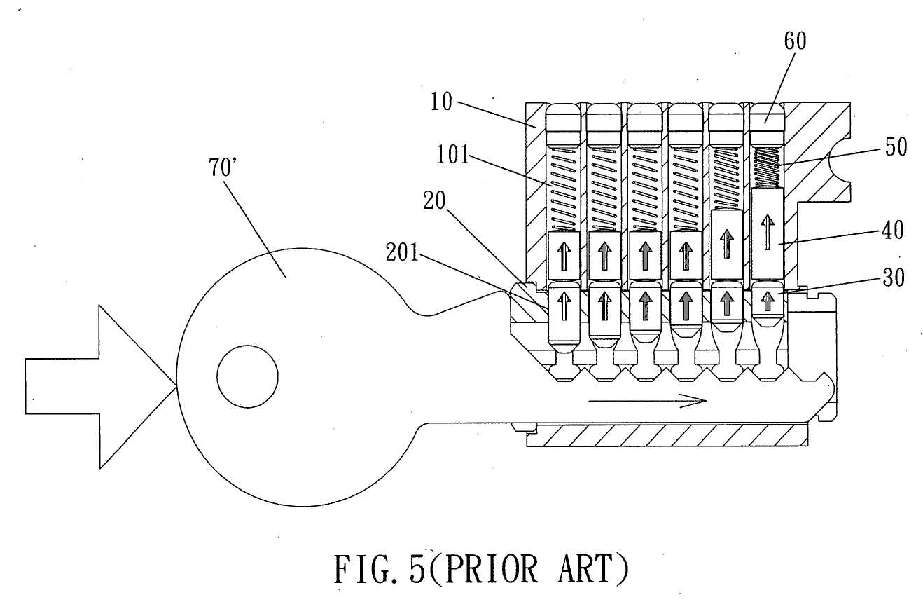

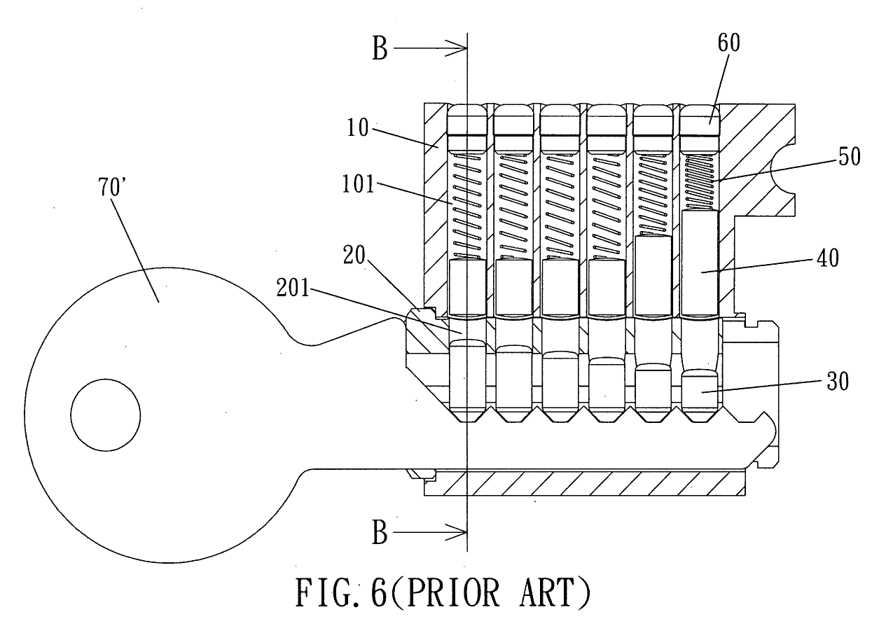

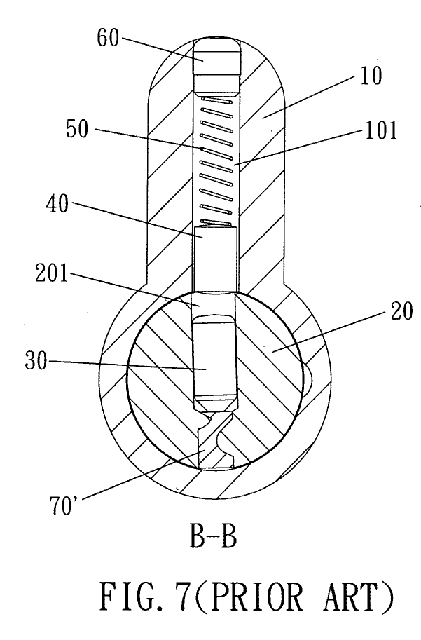

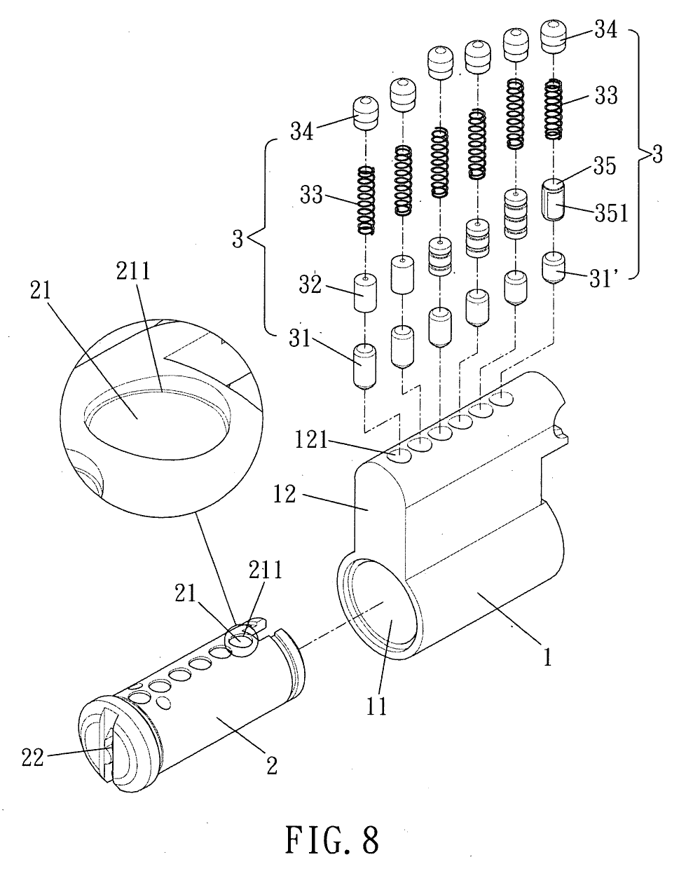

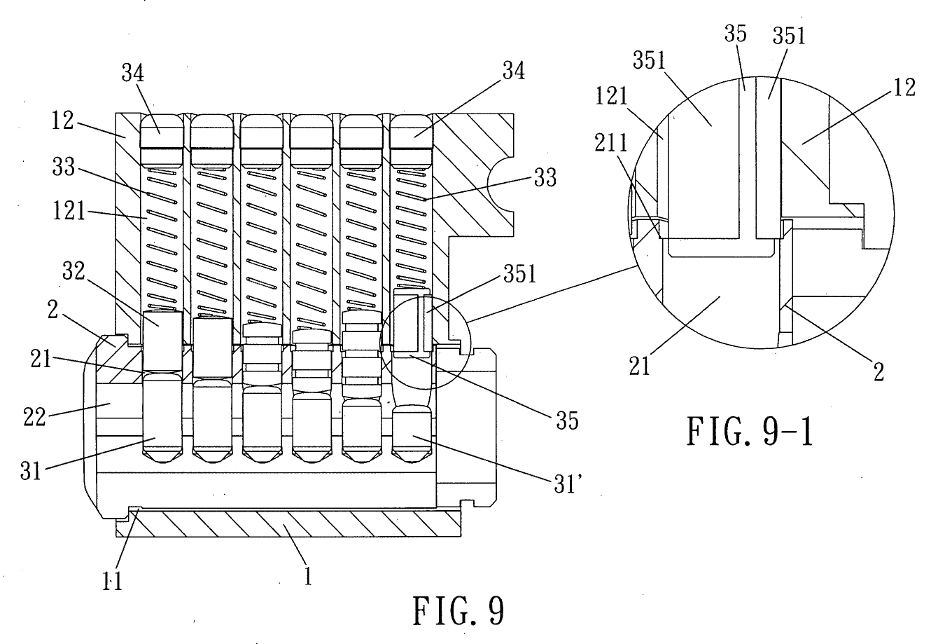

Referring to FIGS. 8, 9 and 9-1, the lock of the present invention comprises a cylinder 1 having a cylindrical recess 11 defined therein and a frame 12 is connected radially to the cylinder 1. Multiple upper pin holes 121 are defined through the frame 12 and perpendicularly communicate with the cylindrical recess 11.

A core 2 is rotatably received in the cylindrical recess 11 and multiple lower pin holes 21 are defined radially through a wall of the core 2. A keyhole 22 is defined in a first end of the core 2 and perpendicularly communicates with the lower pin holes 21. The lower pin holes 21 are in alignment with the upper pin holes 121. Each lower pin hole 21 includes a shoulder 211 located close to the wall of the core 2.

A pin unit 3 includes multiple lower pins 31, upper pins 32, springs 33 and caps 34. The lower pins 31, the upper pins 32, the springs 33 and the caps 34 are installed into the lower pin holes 21 and the upper pin holes 121 in sequence. The lower pins 31 are located in the lower pin holes 21. The bottoms of the lower pins 31 are in contact with the respective inner bottoms of the lower pin holes 21 and the tops of the lower pins 31 are in contact with the bottoms of the upper pins 32. The springs 33 are in contact between the tops of the upper pins 32 and the caps 34 which seal opening of the top pin holes 121. A special lower pin 31′, a special upper pin 35, one of the springs 33 and one of the caps 34 are received in one of the aligned upper pin hole 121 and lower pin hole 21. In this embodiment, the aligned lower and upper pin holes 21, 121 to receive the special lower pin 31′ and the special upper pin 35 are close to a second end of the core 2. The special upper pin 35 includes ridges 351 protruding outward therefrom and has a substantially triangular end cross section. The ridges 351 of the special upper pin 35 are rested on the shoulder 211 of the lower pin hole 21 and a gap is defined between the special upper pin 35 and the special lower pin 31′. It is noted that the size of the substantially triangular end cross section of the special upper pin 35 is wider than the diameter of each of the upper pins 32 and the special lower pin 31′ is shorter than the length of each of the lower pins 31.

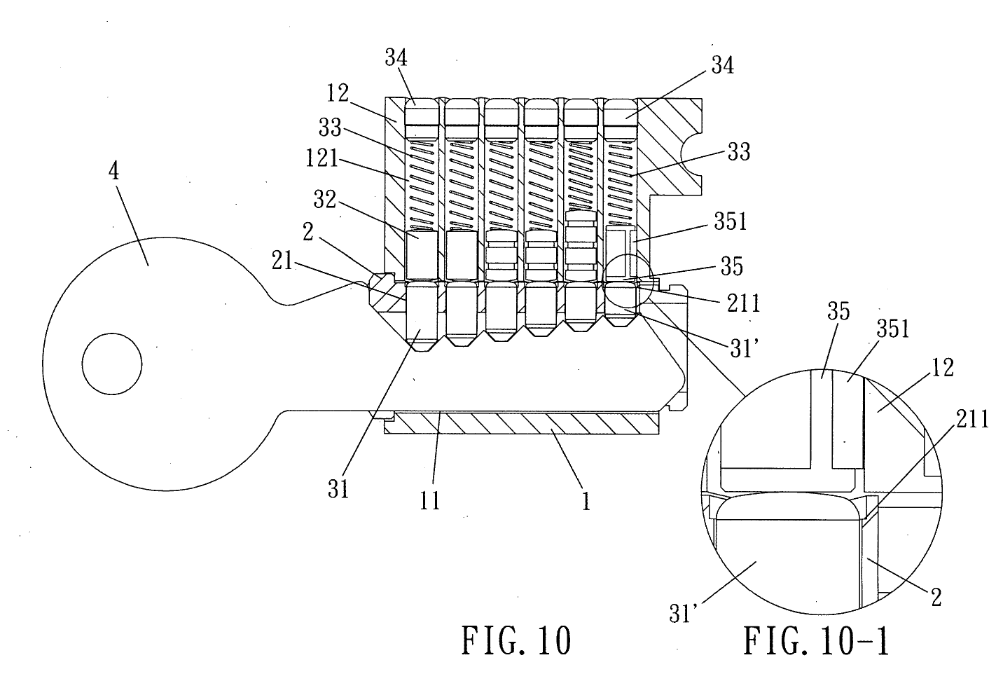

As shown in FIGS. 10 and 10-1, when a correct key 4 is inserted into the keyhole 22, the serrations of the correct key 4 push the lower pins 31, the upper pins 32, the special lower pin 31′ and the special upper pin 35 to correction positions so that the core 2 can be rotated within the cylindrical recess 11 to unlock the lock.

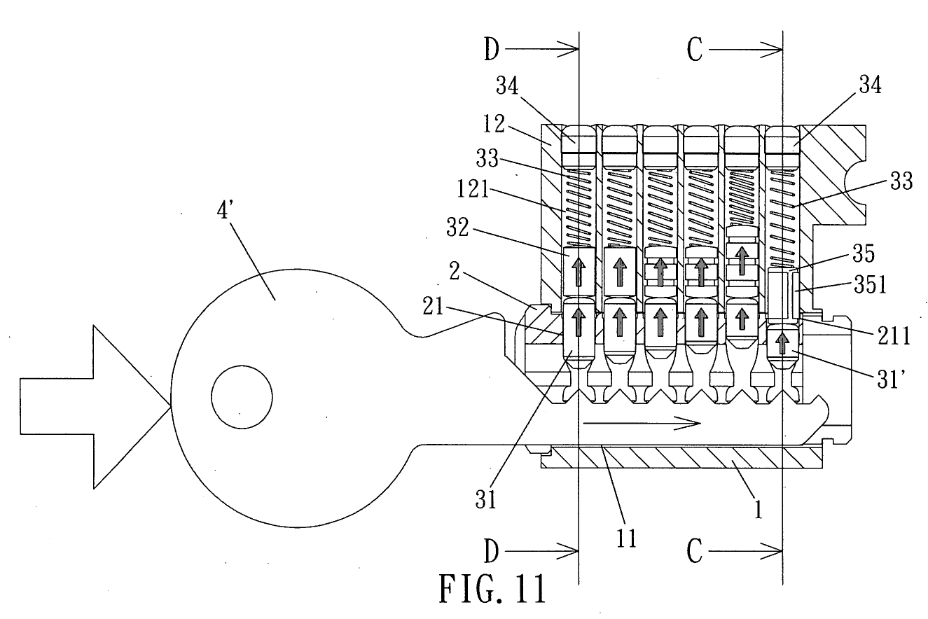

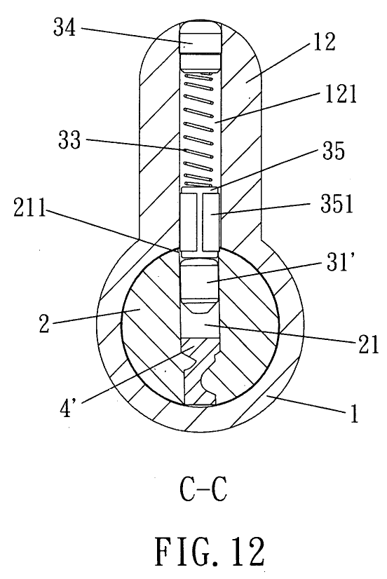

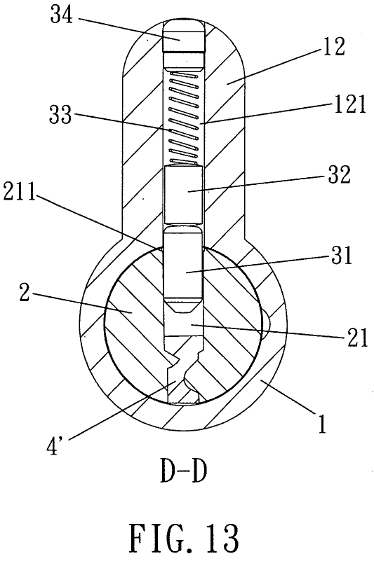

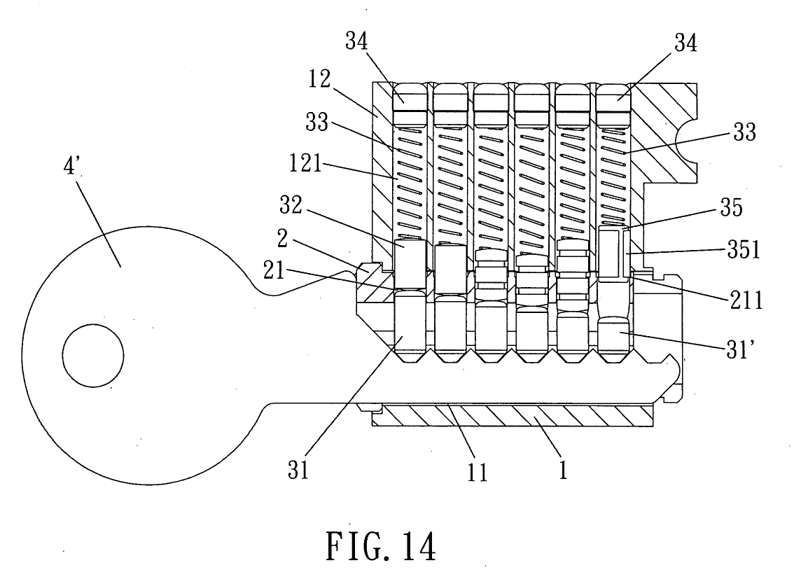

As shown in FIGS. 11, 12 and 13, when the universal key 4′ or an L-shaped plate (not shown) is inserted into the keyhole 22 and rotated a small angle to slightly off align the upper and lower pin holes 121, 21, because of the outer diameter of the special upper pin 35 is slightly larger than the upper pins 32 so that only the ridges 351 are clamped by the insides of the upper pin hole 121 and the lower pin hole 21 as shown in FIG. 12, and the rest of the upper and lower pins 32, 31 are not clamped by the insides of the upper pin hole 121 and the lower pin hole 21. When the universal key 4′ is pushed toward the core 2, lower pins 31 are pushed by the inclined surfaces of the serrations of the universal key 4′ and the lower pins 31 push the upper pins 32. Because the upper pins 32 are not clamped, so that when the springs 33 return, the upper and lower pins 32, 31 will drop as shown in FIG. 14 and the upper pins 32 will not be positioned as in the conventional lock.

Although the special lower pin 31′ moves upward when the universal key 4′ is used, because there is a gap between the special lower pin 31′ and the special upper pin 35, so that the special lower pin 31′ cannot or barely contacts the bottom of the special upper pin 35. The special upper pin 35 is still clamped between the upper and lower pin holes 121, 21 to ensure that the upper pins 32 and the lower pins 31 can drop. By this way, the lock cannot be unlocked by using the universal key.

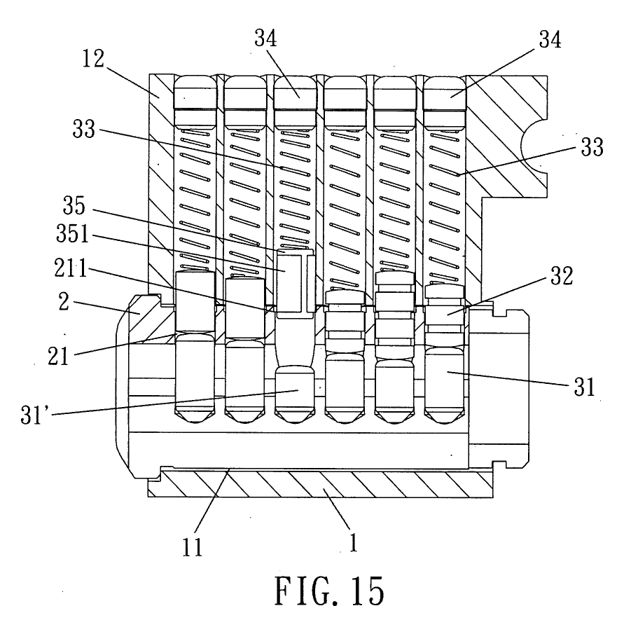

As shown in FIG. 15, the special upper and lower pins 35, 31′ can be installed to any one of the aligned upper and lower pin holes 121, 21. The unauthorized persons cannot predict the position that the special upper and lower pins 35, 31′ are located so that the unauthorized persons cannot make the universal key to match the position that the special upper and lower pins 35, 31′ are located.

While we have shown and described the embodiment in accordance with the present invention, it should be clear to those skilled in the art that further embodiments may be made without departing from the scope of the present invention.

What is claimed is:

1. An anti-theft lock comprising:
a cylinder having a cylindrical recess defined therein and a frame connected radially to the cylinder, multiple upper pin holes defined through the frame and communicating with the cylindrical recess;
a core rotatably received in the cylindrical recess and multiple lower pin holes defined radially through a wall of the core, a keyhole defined in a first end of the core and communicating with the lower pin holes, the lower pin holes being in alignment with the upper pin holes, each lower pin hole including a shoulder located close to the wall of the core, and
a pin unit having multiple lower pins, upper pins, springs and caps, the lower pins, the upper pins, the springs and the caps being installed into the lower pin holes and the upper pin holes in sequence, the lower pins located in the lower pin holes, bottoms of the lower pins being in contact with respective inner bottoms of the lower pin holes and tops of the lower pins being in contact with bottoms of the upper pins, the springs being in contact between tops of the upper pins and the caps which seal opening of the top pin holes, a special lower pin, a special upper pin, one of the springs and one of the caps being received in one of the aligned upper pin hole and lower pin hole, the special upper pin including ridges protruding outward therefrom, the ridges of the special upper pin being rested on the shoulder of the lower pin hole and a gap defined between the special upper pin and the special lower pin.

2. The lock as claimed in claim 1, wherein the special upper pin and the special lower pin are received in the aligned lower and upper pin holes close to a second end of the core.

3. The lock as claimed in claim 1, wherein special lower pin is shorter than a length of each of the lower pins.
